(19) United States
(12) Patent Application Publication
(10) Pub. No.: US 2019/0273287 A1
(43) Pub. Date: Sep. 5, 2019

(54) COMPOSITIONS FOR COATING OF ACTIVE METALS

(71) Applicant: SOLVAY SPECIALTY POLYMERS ITALY S.p.A., Bollate, MI (IT)

(72) Inventors: Luca MERLO, Ixelles (BE); Christine HAMON, Bollate (IT); Claudio OLDANI, Parabiago (IT)

(73) Assignee: SOLVAY SPECIALTY POLYMERS ITALY S.p.A., Bollate, MI (IT)

(21) Appl. No.: 16/334,731

(22) PCT Filed: Sep. 12, 2017
(86) PCT No.: PCT/EP2017/072791

§ 371 Date: Mar. 19, 2019

(30) Foreign Application Priority Data
Sep. 22, 2016 (EP) 16190156.6

(51) Int. Cl. H01M 10/42; H01M 10/0525; H01M 4/36; H01M 4/1395; H01M 4/134; C08F 214/18; C09D 127/12

(52) U.S. Cl. CPC H01M 10/4235; H01M 10/0525; H01M 4/366; C09D 127/12; H01M 4/134; C08F 214/182; H01M 4/1395

(57) ABSTRACT

The present invention provides a multilayer assembly comprising a metallic layer, that is coated at least on one side with a polymeric composition, a method for the preparation of said assembly and an electrochemical cell comprising said multilayer assembly.

### CROSS-REFERENCE TO RELATED APPLICATIONS

This application claims priority to European application No. 16190156.6 filed on 22 Sep. 2016, the whole content of this application being incorporated herein by reference for all purposes.

### TECHNICAL FIELD

The present invention provides a multilayer assembly comprising a metallic layer, that is coated at least on one side with a polymeric composition, a method for the preparation of said assembly and an electrochemical cell comprising said multilayer assembly.

### BACKGROUND ART

Primary (non-rechargeable) batteries containing lithium metal or lithium compounds as an anode are very useful energy storage devices, which may find a variety of applications, ranging from a wide number of portable electronic devices to electrical vehicles.

Lithium (Li) metal would also be an ideal anode material for rechargeable (secondary) batteries due to its excellent electrochemical properties. Unfortunately, uncontrollable dendritic growth and limited Coulombic efficiency during lithium deposition/stripping inherent in rechargeable batteries have prevented the practical applications of Li metal-based rechargeable batteries and related devices over the past 40 years (reference: XU, W., et al. “Lithium metal anodes for rechargeable batteries”. Energy Environ. Sc 2014, vol. 7, p. 513-537, and references cited therein).

With the emergence of post-Li-ion batteries, safe and efficient operation of Li metal anodes is being regarded as an enabling technology which may determine the fate of energy storage technology for the next generation, including rechargeable Li-air batteries, Li—S batteries, and Li metal batteries which utilize intercalation compounds as cathodes (reference: LIANG, Z., et al. “Polymer Nanofiber-Guided Uniform Lithium Deposition for Battery Electrodes”. Nano Lett. 2015, vol. 15, p. 2910-2916, UMEDA, G. A., et al. Protection of lithium metal surfaces using tetraethoxysilane. J. Mater. Chem. 2011, vol. 21, p. 1593, LOVE, C. A., et al. “Observation of Lithium Dendrites at Ambient Temperature”. ECS Electrochemistry Letters. 2015, vol. 4, no. 2, p. A24-A27).

A serious problem of lithium metal anodes is that they are highly reactive. Lithium metal reacts with most of the organic chemicals used in battery electrolytes and it tarnishes in water and air, causing problems during battery production.

Another main issue with the use of Li metal anodes in secondary batteries is linked to the growth of lithium dendrites during repeated charge/discharge cycles, which ultimately lead to poor service life and potential internal short circuits.

Uncontrolled lithium dendrite growth results in poor cycling performance and serious safety hazards (ref. WU, H., et al. “Improving battery safety by early detection of internal shorting with a bifunctional separator”. Nat. Commun. 2014, vol. 5, p. 5193). Upon electrochemical cycling, lithium ions diffuse toward the defects creating the so-called “hot spots”. It is well recognized that Li dendrite growth is accelerated at these hot spots where the current density is locally enhanced dramatically. The resulting tree-like lithium metal dendrite will pierce through the separator and provoke internal short circuits, with risks of overheating, fire and potential explosion of the device.

Lithium dendrite growth could be prevented by adding a polymeric layer on lithium metal. This layer should adhere homogeneously on lithium metal to get homogeneous deposition of lithium and should have also good mechanical properties to resist to dendrite growth, moderate swelling for long lifetime, good ionic conductivity to avoid loss of performance and decrease of lithium concentration at the interface. However, the known coating compositions (e.g. based on vinylidene difluoride polymers) do not suppress dendrite growth to a satisfactory level and lower the overall efficiency of the electrochemical cells.

In fact, the thickness and reactivity of these layers proved difficult to control, and the coatings can interfere with the battery functions, which eventually limits their practical applications.

WO 2016/083271 (Rhodia Operations and COMMISSARIAT ENERGIE ATOMIQUE) discloses a multilayer assembly comprising a metallic layer and a coating layer comprising a fluoropolymer bearing —SO₃H groups: in particular, tetrafluoroethylene-based fluoropolymers are disclosed.

JP 2014210929 (DAIKIN IND LTD) discloses a method for producing a fluorocopolymer comprising a polymerized unit based on a fluorine-containing ethylenic monomer and a polymerized unit having a —SO₃Li group in a side chain.

WO 2012/000851 (Solvay Solexis SPA) discloses a process for the treatment of sulfonyl fluoride polymers with hydrofluoroethers and to the polymer obtained therefrom.

At present, the demand of durable, reliable and safe rechargeable electrochemical cell based on lithium metal anodes is still unmet.

### SUMMARY OF INVENTION

The present invention provides a multilayer assembly, that comprises A multilayer assembly, that comprises:
a metallic layer (a), possessing two surfaces, consisting substantially of a metallic element in its zero oxidation state selected from the group consisting of lithium, sodium, magnesium, zinc, or alloys with at least one of silicon and tin of the said metallic element;
a coating layer (b), which adheres to at least one surface of (a), wherein (b) comprises at least one fluoropolymer (F) which bears —SO₃Y functional groups, Y being selected from the group consisting of H, an alkaline metal and NH₄, wherein (F) comprises recurring units deriving from:
at least one fluorinated olefin monomer (A) bearing at least one —SO₂X functional group, X being selected from X′ and OM, X′ being selected from the group consisting of F, Cl, Br, and I; and M being selected from the group consisting of H, an alkaline metal and NH₄; and
at least one fluorinated olefin monomer (B) selected from the group consisting of
C₂-C₈ perfluoroolefins such as tetrafluoroethylene;
C₂-C₈ hydrogenated fluoroolefins such as vinylidene fluoride (VDF) and 1,2-difluoroethylene;
C₂-C₈ chloro- and/or bromo- and/or iodo-fluoroolefins, such as chlorotrifluoroethylene (CTFE) and bromotrifluoroethylene;
fluoroalkylvinylethers of formula CF₂═CFOR_{f1}, wherein R_{f1} is a C₁-C₆ fluoroalkyl, e.g. —CF₃, —C₂F₅, —C₃F₇;
fluoro-oxyalkylvinylethers of formula CF₂═CFOR_{O1}, wherein R_{O1} is a C₁-C₁₂ fluoro-oxyalkyl group having one or more ether groups, e.g. perfluoro-2-propoxy-propyl group;
fluoroalkyl-methoxy-vinylethers of formula CF₂═CFOCF₂OR_{f2}, wherein R_{f2} is a C₁-C₆ fluoroalkyl group, e.g. —CF₃, —C₂F₅, —C₃F₇, or a C₁-C₆ fluorooxyalkyl group having one or more ether groups, e.g. —C₂F₅—O—CF₃;
fluorodioxoles (MDO) of formula:

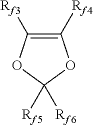

wherein each of R_{f3}, R_{f4}, R_{f5}, R_{f6}, equal to or different from each other, is independently a fluorine atom, a C₁-C₆ fluoroalkyl group, optionally comprising one or more ether oxygen atoms, e.g. —CF₃, —C₂F₅, —C₃F₇, —OCF₃, —OCF₂CF₂OCF₃.

In another embodiment, the present invention provides a process for the preparation of a multilayer assembly as described above, which comprises the steps of:

i. providing a metallic layer (a) possessing two surfaces, consisting substantially of a metallic element in its zero oxidation state selected from the group consisting of lithium, sodium, magnesium, zinc, or alloys with at least one of silicon and tin of the said metallic element;

ii. providing a composition (C) comprising fluoropolymer (F), optionally in mixture with a liquid medium (L1) which comprises a non-aqueous solvent;

iii. coating at least one surface of layer (a) with the composition (C) of step ii.;
iv. optionally, removing the non-aqueous solvent comprised in the liquid medium (L1) to obtain the multilayer assembly.

In a further embodiment, the present invention provides a process for the preparation of a multilayer assembly as described above, which comprises the steps of:

I. providing a metallic layer (a) possessing two surfaces, consisting substantially of a metallic element in its zero oxidation state selected from the group consisting of lithium, sodium, magnesium, zinc, or alloys with at least one of silicon and tin of the said metallic element;

II. providing a composition (C) comprising fluoropolymer (F);

III. processing a fluoropolymer film from the composition (C) obtained in step II.;

IV. laminating the film of step III. onto at least one surface of the metallic layer (a) to obtain the multilayer assembly.

In still a further embodiment, the present invention provides an electrochemical cell comprising the multilayer assembly as described above.

### DESCRIPTION OF EMBODIMENTS

The inventors surprisingly found that the coating of active metal surfaces, such as lithium metal electrodes, with a composition comprising a fluoropolymer (F) as described above, belonging to the class of the so-called “fluorinated ionomers”, lowers or practically suppresses the growth of dendrites in an electrochemical cell assembly, while maintaining very good ionic conductivity. The coating of at least one side of the electrodes, especially in the case of lithium metal electrodes, with said composition provides an electrode with improved properties in terms of ionic conductivity, swelling and resistance against lithium dendrite growth with respect to coating with organic materials, such as vinylidene difluoride (VDF)-based polymers and ionomers comprising recurring units deriving from tetrafluoroethylene, such as Nafion® produced by Du Pont.

Preferably, in the multilayer assembly of the invention layer (a) consists essentially of lithium metal. Advantageously, the lithium metallic layer can be laminated on another metallic layer (preferably copper) on the side that is not coated with composition (b), for providing electrical continuity between electrically conductive surfaces.

In the context of the present invention, the terms “consisting essentially of” or “substantially of” indicate that a composition comprises more than 95% in weight (with respect to the total weight of the composition) of a specific substance (e.g. lithium metal) or consists of such substance, with the proviso that it may include impurities and traces of other substances that are generally or inevitably present in such substance.

Unless otherwise specified, in the context of the present invention the amount of a component in a composition is indicated as the ratio between the weight of the component and the total weight of the composition multiplied by 100 (also: “wt %”).

As used herein, the terms “adheres” and “adhesion” indicate that two layers are permanently attached to each other via their surfaces of contact, e.g. classified as 5B to 3B in the cross-cut test according to ASTM D3359, test method B. For the sake of clarity, multilayer compositions wherein an electrode-type metallic layer (a) and a layer as described above for coating layer (b) are assembled by contacting, e.g. by pressing (a) and (b) together without adhesion between the two layers are outside the context of this invention.

The terms “fluoropolymer” or “fluorinated polymer” as used herein refer to compounds (e.g. polymers, monomers etc.) that are either totally or partially fluorinated, i.e. wherein all or only a part of the hydrogen atoms of an hydrocarbon structure have been replaced by fluorine atoms.

Preferably, the term “perfluorinated” refers to compounds that contain a higher proportion of fluorine atoms than hydrogen atoms, more preferably to compounds that are totally free of hydrogen atoms, i.e. wherein all the hydrogen atoms have been replaced by fluorine atoms (perfluoro compounds).

The terms “fluorinated olefin monomer” as used herein refers to fluorinated products having at least a double bond C═C, optionally containing hydrogen and/or chlorine and/or bromine and/or oxygen, capable of forming (co)polymers in the presence of radical initiators.

Non-limiting examples of suitable fluorinated olefin monomers (A) are: sulfonyl halide fluoroolefins of formula: CF₂═CF(CF₂)ₚSO₂X′ wherein p is an integer between 0 and 10, preferably between 1 and 6, more preferably p is equal to 2 or 3, and wherein preferably X′═F;
sulfonyl halide fluorovinylethers of formula: CF₂═CF—O—(CF₂)ₘSO₂X′ wherein m is an integer between 1 and 10, preferably between 1 and 6, more preferably between 2 and 4, even more preferably m equals 2, and wherein preferably X′═F;
sulfonyl halide fluoroalkoxyvinylethers of formula: CF₂═CF—(OCF₂CF(R_{F1})) w-O—CF₂(CF(R_{F2}))_{y}SO₂X′

wherein w is an integer between 0 and 2, R_{F1} and R_{F2}, equal or different from each other, are independently F, Cl or a C₁-C₁₀ fluoroalkyl group, optionally substituted with one or more ether oxygen atom, y is an integer between 0 and 6, preferably w is 1, R_{F1} is —CF₃, y is 1 and R_{F2} is F, and wherein preferably X′═F;

sulfonyl halide aromatic fluoroolefins of formula CF₂═CF—Ar—SO₂X′ or CF₂ ═CF—O—Ar—SO₂X′, wherein Ar is a C₅-C₁₅ aromatic or heteroaromatic substituent, and wherein preferably X′═F.

Preferably, the at least one fluorinated olefin monomer (A) is selected from the group of the sulfonyl fluorides, i.e. wherein X′═F. More preferably fluorinated olefin monomer (a) is selected from the group of the fluorovinylethers of formula CF₂═CF—O—(CF₂)ₘ—SO₂F, wherein m is an integer between 1 and 6, preferably between 2 and 4. Even more preferably the fluorinated olefin monomer (A) is CF₂═CFOCF₂CF₂—SO₂F (perfluoro-5-sulfonylfluoride-3-oxa-1-pentene, from now on indicated as VEFS).

The at least one fluorinated olefin monomer (B) is preferably selected from the group consisting of:
C₂-C₈ hydrogenated fluoroolefins such as vinyl fluoride and 1,2-difluoroethylene;
chloro- and/or bromo- and/or iodo-C₂-C₆ fluoroolefins, such as chlorotrifluoroethylene (CTFE) and/or bromotrifluoroethylene.

In a preferred embodiment, the at least one fluorinated olefin monomer (B) is vinyl fluoride (VDF) or chlorotrifluoroethylene (CTFE).

In a further embodiment, the fluoropolymer (F) comprises recurring units deriving from at least one fluoropolymer olefin monomer (A), recurring units deriving from vinyl fluoride (VDF) and recurring units deriving from chlorotrifluoroethylene (CTFE).

The multilayer assembly of the present invention may further comprise monomers different from fluorinated olefin monomers (A) and (B).

Suitable additional monomers are selected from the group consisting of hexafluoropropylene (HFP), CF₂═CFOR_{F7}, wherein R_{F7} is a C₁-C₈ alkyl, fluoroalkyl or perfluoro alkyl, optionally comprising at least one heteroatom, MDO as defined above, and mixture thereof.

Preferably in fluoropolymer (F) from 5 to 50 mol %, more preferably from 10 to 25 mol %, of recurring units, based on the total number of moles in (F), are derived from at least one fluorinated olefin monomer (A) as described above.

Preferably, the equivalent weight of fluoropolymer (F) ranges from 340 to 1800, more preferably from 500 to 1000, g/eq.

Preferably, in the multilayer assembly according to the invention, fluoropolymer (F) comprises, as fluorinated olefin monomer (B), recurring units deriving from vinylidene fluoride (VDF) or chlorotrifluoroethylene (CTFE).

Polymers suitable to be used as fluoropolymers (F) in the assembly of the present invention can be prepared according to the methods described in WO 2012/069360 A (SOLVAY SPECIALTY POLYMERS ITALY) 31 May 2012, in US 2005/020941 A (ASAHI KASEI KABUSHIKI KAISHA) 22 Sep. 2005 and in U.S. Pat. No. 8,088,491 B (HUEY-SHEN WU) Mar. 1, 2012.

The inventors found that fluorinated ionomers comprising, as fluorinated olefin monomer (B), recurring units deriving from VDF or CTFE are surprisingly more suitable than analogues comprising tetrafluoroethylene (TFE) as coating layer of active metals such as lithium, in that they are stable under cell operating conditions and in that their ionic conductivity is equal or superior to that of TFE-based perfluorosulfonic acid (PFSA) ionomers.

In particular, test with coin-type cells have shown that little or no degradation is observed in cells where coated lithium assembly according to the invention was used as electrode, whereas total degradation of the electrode (black residues) is found in comparative cells wherein a TFE-based PFSA was used.

Without wishing to be bound by theory, these results can be related to enhanced stability of the fluoropolymer (F) in the assembly according to the invention under the operating conditions of the test batteries.

Enhanced inhibition of dendrimers growth on the metal surface by fluoropolymers (F) is also an advantage of the assemblies according to the invention.

Preferably, in the multilayer assembly according the present invention, the metallic layer (a) is metallic lithium in its zero oxidation state or an alloy of said metallic lithium with silicon or tin.

In another embodiment, the invention provides a process for the preparation of a multilayer assembly as described above, which comprises the steps of:

i. providing a metallic layer (a) possessing two surfaces, consisting substantially of a metallic element in its zero oxidation state selected from the group consisting of lithium, sodium, magnesium, zinc, or alloys with at least one of silicon and tin of the said metallic element;

ii. providing a composition (C) comprising fluoropolymer (F), optionally in mixture with a liquid medium (L1) which comprises a non-aqueous solvent;

iii coating at least one surface of layer (a) with the composition (C) of step ii.;

iv. optionally, removing at least part of the non-aqueous solvent comprised in the liquid medium (L1) to obtain the multilayer assembly;

or which comprises the steps of:

I. providing a metallic layer (a) possessing two surfaces, consisting substantially of a metallic element in its zero oxidation state selected from the group consisting of lithium, sodium, magnesium, zinc, or alloys with at least one of silicon and tin of the said metallic element;

II. providing a composition (C) comprising fluoropolymer (F);

III. processing a fluoropolymer film from the composition (C) obtained in step II.;

IV. laminating the film of step III. onto at least one surface of the metallic layer (a) to obtain the multilayer assembly.

The composition (C) of step ii. is advantageously a solution or a suspension wherein the fluoropolymer (F) is successfully dissolved in the liquid medium (L1).

The liquid medium (L1) typically comprises one or more non-aqueous solvents, selected from the group consisting of NMP (N-Methyl-2-pyrrolidone), DMSO (dimethyl sulfoxide), DMF (dimethylformamide), THF (tetrahydrofuran), NEP (N-ethylpyrrolidone) and organic carbonates.

Non-limiting examples of suitable organic carbonates include cyclic and acyclic carbonates.

Preferred cyclic carbonates include cyclic alkylene carbonates, e.g. ethylene carbonate (EC), propylene carbonate (PC), butylene carbonate, fluoroethylene carbonate and fluoropropylene carbonate. A more preferred unsaturated cyclic carbonate is ethylene carbonate.

Preferred acyclic carbonate include dimethylcarbonate (DMC), diethylcarbonate (DEC), ethylmethylcarbonate (EMC), dimethylethane (DME).

A preferred cyclic carbonate is propylene carbonate.

Removal of the non-aqueous solvent can be partial or complete.

The partial or complete removal of the non-aqueous solvent in optional step iv. can be accomplished by submitting the coated metallic layer to at least one evaporation step by oven drying, at a temperature ranging from 15 to 200° C., preferably from 20 to 150° C. or by exposure to a dry-chamber environment.

Techniques for processing a film from a liquid mixture are known in the art; the composition (C) of step II. is typically processed by casting or by extrusion.

Should the composition (C) be processed by casting, it is typically applied by spreading on a support surface using standard devices, according to well-known techniques like doctor blade coating, metering rod (or Meyer rod) coating, slot die coating, knife over roll coating or “gap coating”, and the like.

The choice of the support surface is not particularly limited, being understood that the fluoropolymer film can be manufactured directly as an unitary assembly or can be manufactured by casting onto another support surface, from which said fluoropolymer film can be detached and individualized.

The support surface is typically made of a composition comprising at least one fluoropolymer having a melting temperature of at least 180° C., preferably of at least 200° C.

The liquid medium (L1) may optionally further comprise fine oxide particles, such as Al₂O₃, TiO₂, SiO₂, dispersed in the non-aqueous solvent.

Generally the weight ratio of fine oxide particles/fluoropolymer (F) will be comprised between 50/50 wt/wt to 1/99 wt/wt, preferably from 30/70 wt/wt to 10/90 wt/wt.

In another embodiment, the present invention provides an electrochemical cell comprising the multilayer assembly as described above, preferably in the form of a rechargeable or primary lithium metal battery, more preferably in the form of a lithium-metal or lithium-sulphur battery.

Should the disclosure of any patents, patent applications, and publications which are incorporated herein by reference conflict with the description of the present application to the extent that it may render a term unclear, the present description shall take precedence.

The following examples are provided to illustrate practical embodiments of the invention, with no intention to limit its scope.

### EXPERIMENTAL PART

Raw Materials (Purchased from Sigma-Aldrich if not Indicated Differently):
LiCu: Lithium with copper metal foil (Honjo metal co, LTD), thickness 30 micron (20 micron Li and 10 micron Cu)
PC: Propylene carbonate, Reagent Plus® 99%
THF: Tetrahydrofuran, >99.9%
VC: Vinylene Carbonate
EC: Ethylene Carbonate
LiPF₆: Lithium hexafluorophosphate
NMC: Lithium nickel manganese cobalt oxide (Umicore) type TX7Ta
Super C65 (Imerys): carbon content>99.5
PVDF (Solef® 75130) copolymer (Solvay Specialty Polymers)

Methods

Preparation of the Battery Used in the Examples

A coin cell testing battery composed of a protected lithium metal, a separator, an electrolyte and positive electrode was prepared.

A microporous membrane from Tonen® type F20BMU was used as separator. It was dried at 80° C. under vacuum for one night before being used in the battery.

NMC (positive electrode): 95% NMC/3% Super C65/2% SOLEF® 5130 PVDF; loading=3.1 mAh/cm². Super C65: carbon powder. The positive electrode was dried for one night under vacuum at 130° C.

The electrode and the separator were placed under argon atmosphere (no oxygen, 0% humidity). 200 μL of electrolyte Selectilyte™ LP30 (ethylene carbonate/dimethyl carbonate 1:1 LiPF6 1 M) with 3% VC were added to the separator. The separator was then placed between the positive electrode and the coated lithium metallic layer (uncoated lithium metallic layer in Comparative Example) in a coin cell, which was tested at room temperature.

### Example 1: Preparation of the VDF-VEFS Polymer Powder in —SO₃Li Form (Polymer F-1)

In a 5 L autoclave the following reagents were charged:
2.6 L of demineralised water;
110 g of the monomer with formula: CF₂═CF—O—CF₂CF₂—SO₂F (VEFS)
160 g of a 5 wt % aqueous solution of F₂ClO(CF₂CF(CF₃)O)ₙ(CF₂O)ₘCF₂COOK (avg. MW=521, ratio n/m=10);

The autoclave, stirred at 650 rpm, was heated at 60° C. A water based solution with 6.0 g/L of potassium persulfate was added in a quantity of 66 mL. The pressure was maintained at a value of 12.3 bar (abs.) by feeding vinylidene fluoride (VDF). After adding 33 g of vinylidene fluoride in the reactor, 25 g of VEFS were added, followed by the addition of 24.5 g of VEFS added every 33 g of vinylidene fluoride fed to the autoclave. The reaction was stopped after 74 min by stopping the stirring, cooling the autoclave and reducing the internal pressure by venting the vinylidene fluoride; a total of 660 g of vinylidene fluoride was fed into the autoclave.

The latex thus obtained was then coagulated by freezing and thawing and the recovered polymer was washed with water and dried at 80° C. for 48 hours. Molar composition of the polymer was determined by NMR to be VDF:VEFS=5.5:1 (corresponding to equivalent weight of 636 g/eq).

The polymer was hydrolysed with a treatment in diluted ammonia (5%) solution at 80° C. for 10 hours (absence of residual SO₂F signal verified by IR on dried powder), then washed with water and exchanged with 20% concentrated HNO₃ at ambient temperature. No signals of polymer degradation (dehydro-fluorination of VDF sequences was observed, since the polymer resulted white/colourless after the treatment).

After washing several times with demineralised water until neutrality is reached a diluted solution of LiOH was added at ambient temperature in excess (double) respect to the stoichiometric value needed to have the complete neutralization of SO₃H→SO₃Li moieties. The powder was finally washed with demineralised water and dried in oven at 80° C. for 48 hours thus obtaining a powder polymer F-1.

### Example 2: Preparation of the CTFE-VEFS Polymer Powder in —SO₃Li Form (Polymer F-2)

In a 5 liter autoclave, the following reactants were introduced:
100 g of a perfluoropolyoxyalkylene microemulsion previously obtained by mixing: 35 g of a perfluoropolyoxyalkylene of formula CF₂ClO(CF₂CF(CF₃)O)ₚ(CF₂O)_{q}CF₂COOK (p/q=10, average molecular weight 527 g/mol) with 25 g of a perfluoropolyether oil Galden® D02 (supplied by Solvay Specialty Polymers Italy SpA) and with 40 g of demineralized water;
2.5 liter of demineralized water;
600 g of CF₂═CF—O—(CF₂)₂—SO₂F (VEFS)
425 g of CTFE.

The autoclave, stirred at 600 rpm, was heated up to 50° C. Total pressure at the reaction temperature was 7.7 atm (abs.). 130 ml of an aqueous solution having a concentration of 50 g/l of potassium persulphate were then fed into the autoclave to initiate the reaction. The pressure was maintained at 7.7 atm (abs) by introducing liquid CTFE from a cylinder. At the end of the reaction a total of 174 g of CTFE were introduced.

Reaction was stopped after 293 minutes from the start. The reactor was heated up at 70° C. for 30 minutes during which the gas phase was vented and then it was cooled down to room temperature.

The produced latex had a solid content of 16.5% by weight. The polymer latex was coagulated by freezing and thawing and the recovered polymer was washed with water and dried for 40 hours at 80° C. The molar composition analysed by NMR resulted in CTFE:VEFS=5, 8:1 (corresponding to equivalent weight of 952 g/eq).

The polymer in —SO₂F form thus obtained was treated for 10 hours with a NaOH solution (10% by weight of NaOH, 10 liters of solution per Kg of polymer) at 80° C. and then washed several times with demineralized water until the pH of the water is <9. Then the polymer was treated with HNO₃ (20% by weight) in order to obtain complete exchange to —SO₃H form. The polymer is then rinsed with water and dried in ventilated oven at 80° C. for 20 h. An excess amount of Li carbonate Li₂CO₃ was then added to the —SO₃H aqueous dispersion under stirring at ambient temperature in order to convert all the —SO₃H group to —SO₃Li form; evolution of CO₂ bubbles was noticed. The polymer powder was then rinsed with water and dried in ventilated oven at 80° C. for 20 h thus obtaining powder F-2.

### Comparative Example 3: Preparation of the TFE-VEFS Polymer Powder in —SO₃Li Form (Polymer F-3)

In a 22 liters autoclave the following reagents were charged:
11.5 liters of demineralized water;
980 g of CF₂═CF—O—CF₂CF₂—SO₂F (VEFS);
3100 g of water solution of CF₂ClO(CF₂CF(CF₃)O)ₙ(CF₂O)ₘCF₂COOK 5% by weight (average molecular weight=521; ratio n/m=10).

The autoclave, stirred at 470 rpm, was heated to a temperature of 60° C., then 150 ml of water solution containing 6 g/liter of Potassium persulfate was added. The pressure was maintained at a value of 12 Bar abs by introducing TFE. After the addition of 1200 g of TFE in the reactor, 220 g of VEFS were added every 200 g of TFE fed to the autoclave.

The stirring was stopped after 280 min, the autoclave was cooled and the internal pressure was reduced by venting the TFE: a total amount of 4000 g of TFE were fed. A latex with a concentration of 28.2% by weight was obtained.

The latex thus obtained was then coagulated by freezing and thawing and the recovered polymer was washed with water and dried for 40 h at 100° C.

Using a suitable amount of the dry polymer, a film was prepared by heating the powder in a press at 270° C. for 5 min. The film was cut in order to have a square 10×10 cm wide and was treated for 24 h in a KOH solution in water (10% by weight) and then, after washing with pure water, in a 20% by weight HNO₃ solution at ambient temperature. The film was finally washed with water. Using this procedure the functional groups of the polymer were converted from the —SO₂F form to —SO₃H. After drying in vacuum at 150° C., the film was titrated with diluted NaOH. The molar composition of the polymer resulted TFE:VEFS=5, 1:1 (the equivalent weight of the polymer corresponding to 790 g/eq).

The remaining amount of the polymer was then treated with a mixture of nitrogen and fluorine gas (50/50) in a MONEL reactor at 80° C. and ambient pressure for 10 hours with a gas flow of 5 NI/hour, and then dried in ventilated oven at 80° C. for 24 hours. The polymer in —SO₂F form obtained was treated for 10 hours with a NaOH solution (10% by weight of NaOH, 10 liters of solution per Kg of polymer) at 80° C. and then washed several times with demineralized water until the pH of the water is <9. Then the polymer was treated with HNO₃ (20% by weight) in order to obtain complete exchange to —SO₃H form. The polymer is then rinsed with water and dried in ventilated oven at 80° C. for 20 h. An excess amount of Li carbonate Li₂CO₃ was then added to the —SO₃H aqueous dispersion under stirring at ambient temperature in order to convert all the —SO₃H group to —SO₃Li form; evolution of CO₂ bubbles was noticed. The polymer powder was then rinsed with water and dried in ventilated oven at 80° C. for 20 h obtaining COMPARATIVE polymer F-3.

### Example 4: Preparation of Polymer Solutions S-1, S-2, S-3, S-4, S-5

Solutions S-1. S-2 and comparative solution S-3 (C. S-3) were prepared, respectively, by dissolving polymer F-1, polymer F-2 and comparative polymer F-3 in propylene carbonate at 80° C. under stirring for 6 hours to obtain homogeneous solutions.

The solutions were cooled down to room temperature. To remove the presence of air, the solutions were degased at 70° C. under vacuum until the absence of any bubble.

Solutions having the following concentration (polymer wt %) were obtained:

S-1: Polymer (F-1) 6.7%

S-2: Polymer (F-2) 5.0%

C. S-3: comparative polymer (F-3) 5.0%

Comparative Solution S-4 (C. S-4) was prepared by dissolving PVDF copolymer (Solef® 75130) in THF at 45° C. under reflux. The solution was then cooled down to room temperature. Molecular sieves were put in the solution to remove any trace of water. Solution C. S-4 concentration (wt % polymer): PVDF 10.0%.

Comparative Solution S-5 (C. S-5):

Alumina (CR6 ® from Baikowsky) was dispersed in propylene carbonate with a centrifugal mixer (speedmixer) at 2500 rpm for 5 min. The resulting dispersion was then mixed with solution S-1 in the centrifugal mixer at 800 rpm for 5 min. A homogeneous solution was obtained. The total solid content (polymer (F-1)+alumina) was 2 wt %. Polymer (F-1)/Alumina ratio was 70/30 wt %.

Solution C. S-5 concentration (wt % polymer+alumina): 2.0%.

### Example 5: Measurement of the Ionic Conductivity of Self-Standing Polymeric Layers Obtained from Solutions S-1, S-2, C. S-3, and C. S-4

Polymeric layers were obtained by coating inert PTFE supports with solutions S-1, S-2, C. S-3 and C. S-4 by doctor blade technique and drying for one night under vacuum at 100° C. The PTFE was removed thus obtaining self-standing polymeric films with a thickness of about 20 μm.

The films were placed in coin cells between two stainless steel disks (operation carried out in glove box), and the ionic conductivity (a) was calculated using the following equation: σ=d/(Rb×S) wherein:

d is the thickness of the film, typically comprised between 10 and 50 μm,

Rb is the bulk resistance of the polymeric layer, measured via impedence-spectroscopy (frequency from 1 MHz to 200 mHz, perturbation 5 mV) using the Nyquist plot, and

S is the area of the stainless steel electrode, which is typically circular, with a 16 mm diameter.

The results are summarized In Table 1.

TABLE 1

Ionic conductivity (S/cm)

| Precursor solution | T = 24° C. | T = 60° C. | T = 80° C. |
|---|---|---|---|
| S-1 | 2.3E−06 | 5.0E−06 | 5.4E−06 |
| S-2 | 1.3E−07 | 1.3E−07 | 1.3E−07 |
| C. S-3 | 6.5E−07 | 7.5E−07 | 8.6E−07 |
| C. S-4 | NaN | NaN | NaN |

The conductivity value of the film obtained from solution C. S-4 (PVDF) was too low to be measured.

### Example 6: C-Rate Performance Test of Batteries Assembled with Li Metal Foils Protected with Polymer Solutions

Solutions S-1, C. S-3, C. S-4 and C. S-5 were cast on lithium metal foil (this step was carried out in glove box) by doctor blade technique. The coating was dried 2 h at room temperature and then 2 h at 105° C. The final coating thickness was in the range of 8 to 10 μm.

Coin cells assembled as previously described were prepared and cycled between 2.8 V and 4.2 V.

After a step of 2 cycles at 0.1C-0.1 D, the test protocol was carried out according to successive series of 2 cycles at 0.2C-0.2D, 0.2C-0.5D, 0.2C-1 D, 0.2C-2D, 0.2C-2D, 0.2C-5D, 0.2C-10D and 0.2C-0.2D.

The discharge capacity values of the coin cells under different discharge rates were then obtained and compared with an identical assembly with Li foil without any coating (NO COATING herein after).

The C-rate is a measure of the rate at which a battery is being charged or discharged. It is defined as the current divided by the theoretical current draw under which the battery would deliver its nominal rated capacity in one hour.

The results are summarized in Table 2.

TABLE 2

| | Average Discharge Capacity [mAh/g] | | | | |
|---|---|---|---|---|---|
| C-Rate | NO | | | | |
| (discharge) | COATING | S-1 | C. S-3 | C. S-4 | C. S-5 |
| 0.1 | 144 | 142 | 145 | 143 | 140 |
| 0.2 | 138 | 138 | 140 | 137 | 136 |
| 0.5 | 131 | 132 | 134 | 135 | 130 |
| 1 | 124 | 126 | 124 | 129 | 123 |
| 2 | 115 | 117 | 107 | 113 | 121 |
| 5 | 58 | 66 | 54 | 43 | 91 |

### Example 7: Stability Test of Batteries Assembled with Li Metal Foils Protected with Polymer Solutions

After the C-rate performance test of Example 6, the coin cells were continuously cycled at 1C-1 D until a drop of performance superior to 80% of the initial performance.

The results are summarized in Table 3.

TABLE 3

| | NO | | | | |
|---|---|---|---|---|---|
| | COATING | S-1 | C. S-3 | C. S-4 | C. S-5 |
| Average Discharge | 126 | 126 | 125 | 123 | 125 |
| capacity after 2^{nd} cycle | | | | | |
| Number of cycles to | 21 | 43 | 29 | 23 | 32 |
| reach 80% of the | | | | | |
| discharge capacity | | | | | |
| after 2^{nd} cycle | | | | | |

The results show the highest durability of the coin cell battery prepared by using the multilayer assembly of the invention.

### Example 8: Lithium Efficiency Test of Batteries Assembled with Li Metal Foils Protected with Polymer Solutions

Solutions S-1, C. S-3, C. S-4 and C. S-5 were casted on the thin lithium metal foil (this step was carried out in glove box) by doctor blade technique. The coatings were dried 2 h at room temperature and then 2 h at 105° C. The final coating thickness was in the range of 8 to 10 μm. Batteries composed of thin protected lithium metal on copper, separator, electrolyte and 380-um thick lithium metal were prepared.

Two electrodes having different Li amount were used: a limiting electrode (working electrode) and a Li excess electrode (counter/reference electrode).

The separator was a 260 μm thick glass fiber membrane Whatman®. The separator was dried at 250° C. under vacuum for one night before assemblying.

200 μL of electrolyte Selectilyte™ LP30 (ethylene carbonate/dimethyl carbonate 1:1 LiPF6 1M) with 3% VC was added to the separator.

The membrane was then placed between the thick lithium metal and the coated lithium metal foil (uncoated in case of comparative test) in a coin cell and it is tested at 24° C.

The cycling performance of Li during plating/stripping repeated cycles was investigated.

Galvanostatic tests were performed at 0.8 mA/cm² with cut-off voltage of 3 V and the current is reversed every 190 minutes in order to remove/deposit always the same quantity of lithium, equal to that of limiting electrode. Tests were stopped when voltage reached cut off, due to limiting electrode depletion. The number of cycles were correlated to lithium deposition/stripping efficiency using the equation: efficiency=N/(N+1) wherein N=number of charge/discharge cycles before cut-off.

TABLE 4

| | NO | | | | |
|---|---|---|---|---|---|
| | COATING | S-1 | C. S-3 | C. S-4 | C. S-5 |
| Number of cycles | 26 | 27 | 31 | 14 | 28 |
| before reaching | | | | | |
| cut-off voltage | | | | | |

After finishing the test, the coin cells were opened, the coated lithium and separator were immersed in water to observe if some degradation products were formed. Black residuals were present in the cell prepared with solution C. S-3; in contrast, no residual was observed in the coin cells prepared by coating Li with solutions S-1, S-2 and C. S-4 and the coin cell containing uncoated Li foil (NO COATING).

The experimental results show that the multilayer assemblies according to the invention exhibit a very satisfactory compromise of properties, for example as regards their ionic conductivity, chemical stability and C-rate performance compared with Li foils coated with TFE-VEFS polymer, with PVDF or without any coating.

In particular, multilayer assemblies coated with fluoropolymer (F-1) show the best combination of ionic conductivity, chemical stability and C-rate performance compared with metallic layers coated with PFSA ionomer (F-3), PVDF (F-4) or in the absence of any polymer coating (uncoated Li metal).

1. A multilayer assembly, that comprises:
a metallic layer (a), possessing two surfaces, consisting essentially of a metallic element in its zero oxidation state selected from the group consisting of lithium, sodium, magnesium, and zinc, or alloys of the metallic element with at least one of silicon and tin;
a coating layer (b), which adheres to at least one surface of (a), wherein (b) comprises at least one fluoropolymer (F) which bears —SO₃Y functional groups, Y being selected from the group consisting of H, an alkaline metal and NH₄, wherein fluoropolymer (F) comprises recurring units derived from:
at least one fluorinated olefin monomer (A) bearing at least one —SO₂X functional group, X being selected from X′ and OM, X′ being selected from the group consisting of F, Cl, Br, and I; and M being selected from the group consisting of H, an alkaline metal and NH₄; and
at least one fluorinated olefin monomer (B) selected from the group consisting of
C₂-C₈ perfluoroolefins;
C₂-C₈ hydrogenated fluoroolefins;
C₂-C₈ chloro- and/or bromo- and/or iodo-fluoroolefins;
fluoroalkylvinylethers of formula CF₂═CFOR_{f}n, wherein R_{f1} is a C₁-C₆ fluoroalkyl;
fluoro-oxyalkylvinylethers of formula CF₂═CFOR_{O1}, wherein R_{O1} is a C₁-C₁₂ fluoro-oxyalkyl group having one or more ether groups,
fluoroalkyl-methoxy-vinylethers of formula CF₂═CFOCF₂OR_{f2}, wherein R_{f2} is a C₁-C₆ fluoroalkyl group or a C₁-C₆ fluorooxyalkyl group having one or more ether groups;
fluorodioxoles (MDO) of formula: 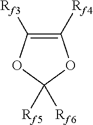
wherein each of R_{f}, R_{f4}, R_{f5}, R_{f6}, equal to or different from each other, is independently a fluorine atom or a C₁-C₆ fluoroalkyl group, optionally comprising one or more ether oxygen atoms.

2. The multilayer assembly according to claim 1, wherein fluoropolymer (F) comprises recurring units derived from at least one monomer (A) selected from:
sulfonyl halide fluoroolefins of formula: CF₂═CF(CF₂)ₚSO₂X′ wherein p is an integer between 0 and 10;
sulfonyl halide fluorovinylethers of formula: CF₂═CF—O—(CF₂)ₘSO₂X′ wherein m is an integer between 1 and 10;
sulfonyl halide fluoroalkoxyvinylethers of formula: CF₂═CF—(OCF₂CF(R_{F1}))_{w}—O—CF₂(CF(R_{F2}))_{y}SO₂X′
wherein w is an integer between 0 and 2, R_{F1} and R_{F2}, equal or different from each other, are independently F, Cl or a C₁-C₁₀ fluoroalkyl group, optionally substituted with one or more ether oxygen atom, y is an integer between 0 and 6;
sulfonyl halide aromatic fluoroolefins of formula CF₂═CF—Ar—SO₂X′ or CF₂═CF—O—Ar—SO₂X′
wherein Ar is a C₅-C₁₅ aromatic or heteroaromatic substituent.

3. The multilayer assembly according to claim 2, wherein fluoropolymer (F) comprises recurring units derived from
at least one fluorinated olefin monomer (A) selected from the group consisting of fluorovinylethers of formula CF₂═CF—O—(CF₂)ₘ—SO₂F, wherein m is an integer between 1 and 6, and
at least one fluorinated olefin monomer (B) is selected from:
C₃-C₈ fluoroolefins;
chloro- and/or bromo- and/or iodo-C₂-C₆ fluoroolefins;
fluoroalkylvinylethers of formula CF₂═CFOR_{f1} wherein R_{f1} is a C₁-C₆ fluoroalkyl;
fluoro-oxyalkyl-vinylethers of formula CF₂═CFOR_{O1}, wherein R_{O1} is a C₁-C₁₂ fluorooxyalkyl having one or more ether groups.

4. The multilayer assembly according to claim 3, wherein fluorinated olefin monomer (A) is CF₂═CFOCF₂CF₂—SO₂F (perfluoro-5-sulfonylfluoride-3-oxa-1-pentene) and/or fluorinated olefin monomer (B) is vinylidene fluoride (VDF) and/or chlorotrifluoroethylene (CTFE).

5. The multilayer assembly according to claim 1, wherein the equivalent weight of fluoropolymer (F) is from 340 to 1800 g/eq.

6. The multilayer assembly according to claim 1, wherein from 5 to 50 mol % of recurring units in fluoropolymer (F), based on the total number of moles in fluoropolymer (F), are derived from at least one fluorinated monomer comprising —SO₂X.

7. The multilayer assembly according to claim 1, wherein (a) is metallic lithium in its zero oxidation state or an alloy of metallic lithium with silicon or tin.

8. A process for the preparation of a multilayer assembly according to claim 1, the process comprising coating at least one surface of a metallic layer (a) with a composition (C) wherein:
metallic layer (a) possesses two surfaces and consists essentially of a metallic element in its zero oxidation state selected from the group consisting of lithium, sodium, magnesium, and zinc, or alloys of the metallic element with at least one of silicon and tin, and
composition (C) comprises fluoropolymer (F), optionally in mixture with a liquid medium (L1) comprising a non-aqueous solvent;
optionally, removing at least part of the non-aqueous solvent comprised in the liquid medium (L1) to obtain the multilayer assembly.

9. A process for the preparation of a multilayer assembly according to claim 1, the process comprising:
processing a fluoropolymer film from a composition (C), said composition (C) comprising fluoropolymer (F); and
laminating the fluoropolymer film onto at least one surface of a metallic layer (a) to obtain the multilayer assembly, wherein metallic layer (a) possesses two surfaces and consists essentially of a metallic element in its zero oxidation state selected from the group consisting of lithium, sodium, magnesium, and zinc, or alloys of the metallic element with at least one of silicon and tin.

10. An electrochemical cell comprising the multilayer assembly of claim 1.

11. The electrochemical cell according to claim 10 in the form of a rechargeable or primary lithium metal battery.

12. The electrochemical cell according to claim 10 in the form of a lithium-metal or lithium-sulphur battery.

13. The multilayer assembly according to claim 1, wherein fluorinated olefin monomer (B) is selected from the group consisting of:
tetrafluoroethylene; vinylidene fluoride (VDF); 1,2-difluoroethylene; chlorotrifluoroethylene (CTFE); bromotrifluoroethylene; fluoroalkylvinyl ethers of formula CF₂═CFOR_{f1} wherein R_{f1} is —CF₃, —C₂F₅, or —C₃F₇; fluoro-oxyalkylvinylethers of formula CF₂═CFOR_{O1} wherein R_{O1} is perfluoro-2-propoxy-propyl; fluoroalkyl-methoxy-vinylethers of formula CF₂═CFOCF₂OR_{f2} wherein R_{f} is —CF₃, —C₂F₅, —C₃F₇, or —C₂F₅—O—CF₃; and fluorodioxoles (MDO) of formula: 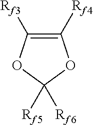
wherein each of R_{f3}, R_{f4}, R_{f5}, R_{f6}, equal to or different from each other, is independently a fluorine atom, —CF₃, —C₂F₅, —C₃F₇, —OCF₃, or —OCF₂CF₂OCF₃.

14. The multilayer assembly according to claim 2, wherein fluoropolymer (F) comprises recurring units derived from at least one monomer (A) selected from:
sulfonyl halide fluoroolefins of formula: CF₂═CF(CF₂)ₚSO₂X′ wherein p is an integer between 1 and 6, and X′ is F;
sulfonyl halide fluorovinylethers of formula: CF₂═CF—O—(CF₂)ₘSO₂X′ wherein m is an integer between 1 and 6, and X′ is F;
sulfonyl halide fluoroalkoxyvinylethers of formula: CF₂═CF—(OCF₂CF(R_{F1}))_{w}—O—CF₂(CF(R_{F2}))_{y}SO₂X′ wherein w is 1, R_{F1} is —CF₃, y is 1, R_{F2} is F, and X′ is F;
sulfonyl halide aromatic fluoroolefins of formula CF₂═CF—Ar—SO₂X′ or CF₂═CF—O—Ar—SO₂X′ wherein Ar is a C₅-C₁₅ aromatic or heteroaromatic substituent, and X′ is F.

15. The multilayer assembly according to claim 14, wherein fluoropolymer (F) comprises recurring units derived from at least one monomer (A) selected from:
sulfonyl halide fluoroolefins of formula: CF₂═CF(CF₂)ₚSO₂X′ wherein p is equal to 2 or 3, and X′ is F;
sulfonyl halide fluorovinylethers of formula: CF₂═CF—O—(CF₂)ₘSO₂X′ wherein m is an integer between 2 and 4, and X′ is F.

16. The multilayer assembly according to claim 3, wherein fluoropolymer (F) comprises recurring units derived from
at least one fluorinated olefin monomer (A) selected from the group consisting of fluorovinylethers of formula CF₂═CF—O—(CF₂)ₘ—SO₂F, wherein m is an integer between 2 and 4, and
at least one fluorinated olefin monomer (B) is selected from vinylidene fluoride (VDF); chlorotrifluoroethylene; bromotrifluoroethylene; fluoroalkylvinylethers of formula CF₂═CFOR_{f1} wherein R_{f1} is —CF₃, —C₂F₅, —C₃F₇; or fluoro-oxyalkyl-vinylether of formula CF₂═CFOR_{O1} wherein R_{O1} is perfluoro-2-propoxy-propyl.
